(19) United States
(12) Patent Application Publication
(10) Pub. No.: US 2018/0045208 A1
(43) Pub. Date: Feb. 15, 2018

(54) ELECTRIC MOTOR FOR A FLUID CIRCULATOR

(71) Applicant: Taco Italia S.r.l., Sandrigo (VI) (IT)

(72) Inventors: DARIO BEDIN, Marostica (Vicenza) (IT); ROBERTO MONDIN, Paese (Treviso) (IT)

(73) Assignee: Taco Italia, S.r.l., Sandrigo (VI) (IT)

(21) Appl. No.: 15/673,879

(22) Filed: Aug. 10, 2017

(30) Foreign Application Priority Data
Aug. 10, 2016 (IT) 102016000084440

(51) Int. Cl. F04D 29/041; F04D 29/053; F04D 29/051; H02K 7/08; F04D 25/06; H02K 1/27; H02K 7/14; F04D 29/043; F04D 13/06

(52) U.S. Cl. CPC F04D 29/041; F04D 29/043; F04D 29/053; F04D 29/051; F04D 13/06; F04D 25/06; H02K 1/27; H02K 7/14; H02K 7/08; F04D 1/00

(57) ABSTRACT

The invention relates to an improved electric motor for a fluid circulator comprising a permanent magnet rotor (2), a stator (3), in which a supporting and containing hollow body (4) for the rotor (2) is housed, an impeller (5), a shaft (6) of the electric motor kinematically coupled to the rotor (2) and to the impeller (5) for activating the impeller (5) in rotation. Advantageously, the rotor (2) comprises an axial thrust bearing member (7; 10), made of anti-friction material and adapted for supporting axil loads produced during the fluid circulation in the circulator, said thrust bearing member being integrated inside the rotor itself, so that the thrust bearing member does not separate from the rotor during a motor disassembly.

### BACKGROUND OF THE INVENTION

### Field of Application

The present invention relates to a synchronous permanent magnet motor preferably used in fluid driving pumps and, in particular, circulators for fluid heating and/or cooling plants.

### Prior Art

Centrifugal electric pumps, generally known with the name of circulators, are used for the circulation of the vector fluid in the context of heating plants.

As known in the technical field, a circulator generally comprises a synchronous electric motor, the rotor of which is clamped on a shaft that has an end kinematically coupled to an impeller activated by the electric motor itself.

The circulators can have impellers of various shapes and propulsion purposes for the treated fluid; in the case of impellers having curved blades of the centrifugal type, the pulse given to the fluid produces an axial thrust due to the pressure gradient that is produced between the suction and delivery areas in the volute where the impeller rotates. In centrifugal pumps, the above areas are always placed with the suction area belonging to the impeller in axis with the rotation shaft and the delivery in an annular area outside the diameter of the impeller and coplanar thereto.

This arrangement produces an axial thrust acting on the impeller, resulting from the axial component of the difference between the pressure range upstream and downstream of the impeller, i.e., between the suction of the inlet, located substantially in front of the impeller and the pressure of the outlet, located substantially to the side of the impeller; the thrust is such as to tend to move the impeller towards the inlet duct.

In the type of electric pumps for fluids involved by the present invention, electric pumps are known in which the electric motor is of the synchronous type, that is, preferably having a permanent magnet rotor housed within a tubular, overmolded housing, preferably located substantially concentrically within the stator pack and its electrical windings. The stator pack with the windings is separated outside of the tubular housing to ensure electric insulation, and to protect the electrical windings from any fluid that may leak past the impeller. The rotor and housing is held centrally of the stator pack in a removable manner, so as to allow an easy assembly and possible extraction for maintenance purposes.

It is known state of the art to support the rotor with supporting bushings made of anti-friction material: the bushing on the side of the impeller also supports the axial thrust transmitted by the impeller to the motor through the motor shaft. The contact between the axial abutment of the supporting bush and the rotor occurs through a thrust bearing disc made of a hard and abrasion-resistant material, inserted between the axial abutment and the end of the rotor. The prior art generally placed a thrust bearing by means of an annular seat which is recessed and made integral with the motor shaft: the seat and the disc are axially blocked on the shaft in a proper position in order to centrally place the rotor on the stator, with the rotor end contacting the thrust bearing disc.

A known solution is disclosed for instance in the European patent application No. EP 1 612 427 A1 wherein said bearing disc has been removed so that the axial thrust is supported directly by one side of the rotor. However, this solution has shown resistance problems and the working life of this kind of motors is reduced by virtue of the direct abrasion of the rotor magnet by the thrust bearing.

Therefore, in the state of the art, the axial thrusts support is known through the interposition of a suitable member, precisely the thrust bearing disc, and of additional accessory parts such as the containing annular seat made of elastic material.

The technical problem underlying the present invention is that to conceive an electric motor for a fluid circulator comprising a thrust bearing member of simplified construction, reducing the axial dimensions, making the assembly more practical and simplifying the maintenance of the axial thrust bearing on the impeller side, all this in the perspective of a simple and rational constructive solution. The present invention unexpectedly provides the improved results

Aim of the present invention is to meet the above need meanwhile overcoming the above-mentioned drawbacks of the prior art.

### BRIEF SUMMARY OF THE INVENTION

Said aim is achieved by an electric motor for a fluid circulator in accordance with claim 1 of the present invention.

The dependent claims outline preferred and particularly advantageous embodiments of the connection unit according to the invention.

Further features and advantages will become clearer from the detailed description below reported of a preferred, but not exclusive, embodiment of the present invention, with reference to the enclosed figures given by way of example and not for limiting purposes.

### BRIEF DESCRIPTION OF THE DRAWINGS

FIG. 1 shows a perspective view of a circulator comprising an electric motor in accordance with the present invention;

FIG. 2 shows a section view of the circulator of FIG. 1 with an electric motor made in accordance with a first embodiment;

FIG. 3 shows a section view of the circulator of FIG. 1 with an electric motor made in accordance with a second embodiment;

FIG. 4 shows a magnet with an axial thrust bearing member in accordance with the first embodiment of the invention;

FIG. 5 shows a magnet with an axial thrust bearing member in accordance with FIG. 4;

FIG. 6 shows a magnet with an axial thrust bearing member in accordance with the second embodiment of the invention.

### DETAILED DESCRIPTION OF THE INVENTION

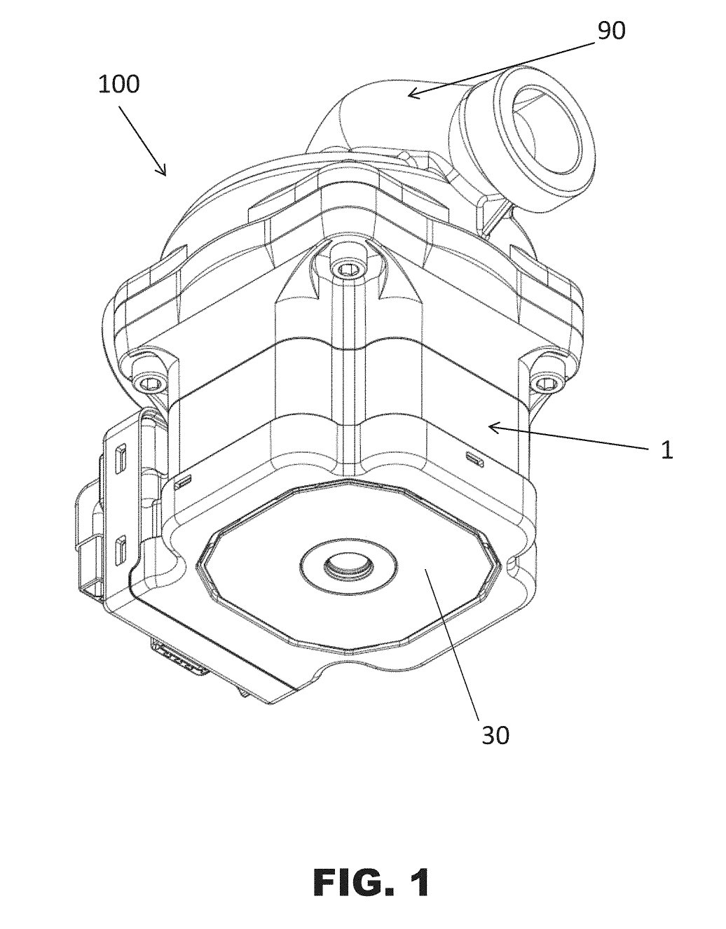

With reference to the enclosed FIGS. 1-3, 100 denotes a circulator, namely an electric motor powered pump made according to the present invention. The circulator comprises and is activated by a synchronous permanent magnet electric motor 1 and is intended for driving fluids and in particular in heating and/or cooling plants.

Generally, the circulator 100 is made through the coupling of a centrifugal pump 90 with the electric motor 1.

The electric motor 1 comprises a permanent magnet rotor 2, a stator 3, in which a sleeve 21 for supporting and containing the rotor 2 is housed; the centrifugal pump comprises an impeller 5 housed within an annulus having a suction inlet and a pressurized outlet, the annulus being part of an integral outer housing for the circulator 100. The shaft 6 of the electric motor that is [integral]integrated with the rotor is kinematically coupled to the impeller 5 for activating the impeller 5 to rotate.

The rotor 2 and the connection to the shaft 6 are housed in the tubular separator sleeve 21 that isolates them from the stator and its electrical windings 3. The sleeve 21 has a tubular body 22, preferably made of an insulating plastic, preferably a techno-plastic material and tapered at one end 18; and having the opposite open end integrally connected with a flange 24.

Inside the tubular body 22 the rotor 2 is housed with the respective shaft 6 that protrudes towards the inner part of the end 18 where a bearing support 118 for supporting the motor shaft 6 is preferably provided.

The end 18 of the sleeve 21 is closed by a removable cup 25 that is provided with a lowered notch 27 for the insertion of a maneuvering tool, for mounting a sealing gasket on the end 18.

The flange 24 is closed by a cup 30, in turn made of plastic material, which represents a separation wall between the sleeve 21 and the pump body 90 of the pump 1. The plastic material of which the flange 24 is made of is the same as the material of which the cup 30 is made.

Substantially, the cup 30 is a disc made of plastic synthetic material that constitutes a separation wall between the sleeve for housing the rotor 2 and the volute 4 in which the impeller 5 rotates, namely the volute 4 of the pump body 90. The motor shaft 6 axially passes through a central opening through the cup 30 and is firmly connected to the impeller 5 through a brass bushing which is molded with the cup 30 to connect with the impeller; this allows the impeller to rotate together with the shaft 6, preferably without slippage.

In accordance with the present invention, the shaft 6 of the rotor 2 is connected to an axial thrust bearing surface member 7 made of anti-friction material adapted for supporting axial loads that are produced during the fluid circulation in the circulator.

The thrust bearing member 7 is placed directly in contact with a bushing bearing 20 clamped around the motor shaft 6; the bushing bearing is supported from the flange 24, and interposed between the rotor 2 and the impeller 5.

Preferably, in accordance with the present invention, said thrust bearing member is integrated with the rotor 2, within the tube 22 surrounding the rotor 2 itself, so that the thrust bearing member does not separate from the rotor 2 during disassembly of the electric motor 1.

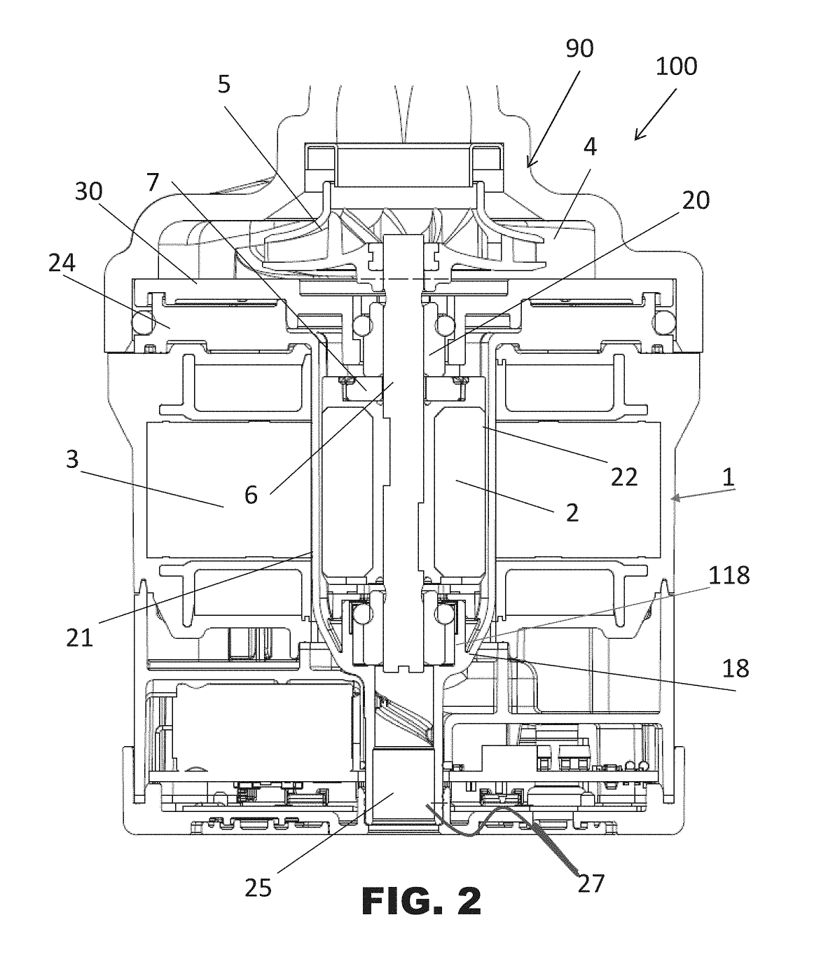

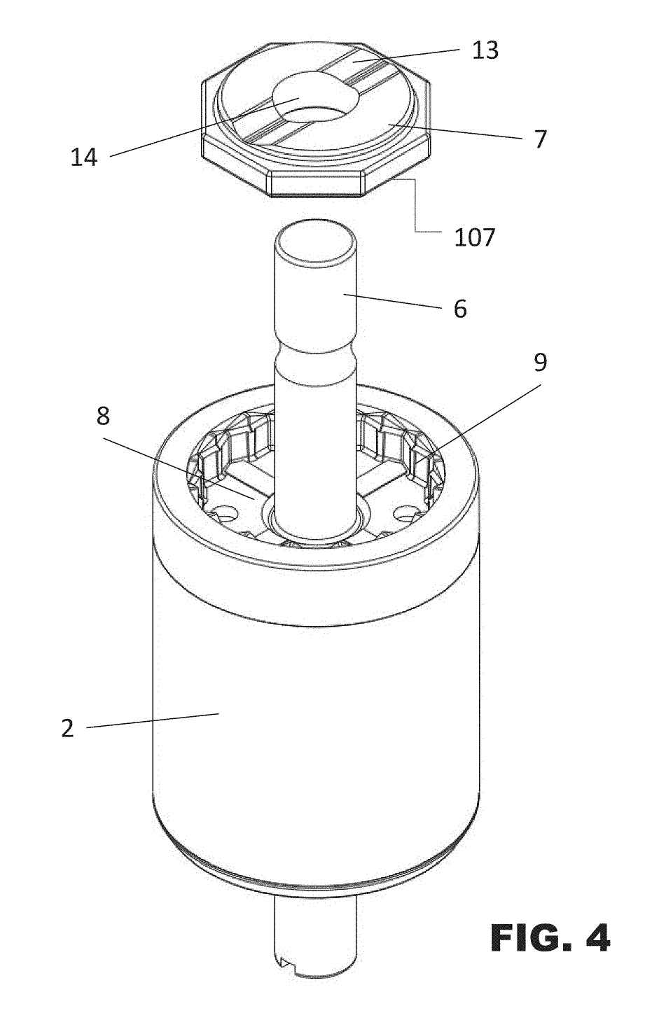

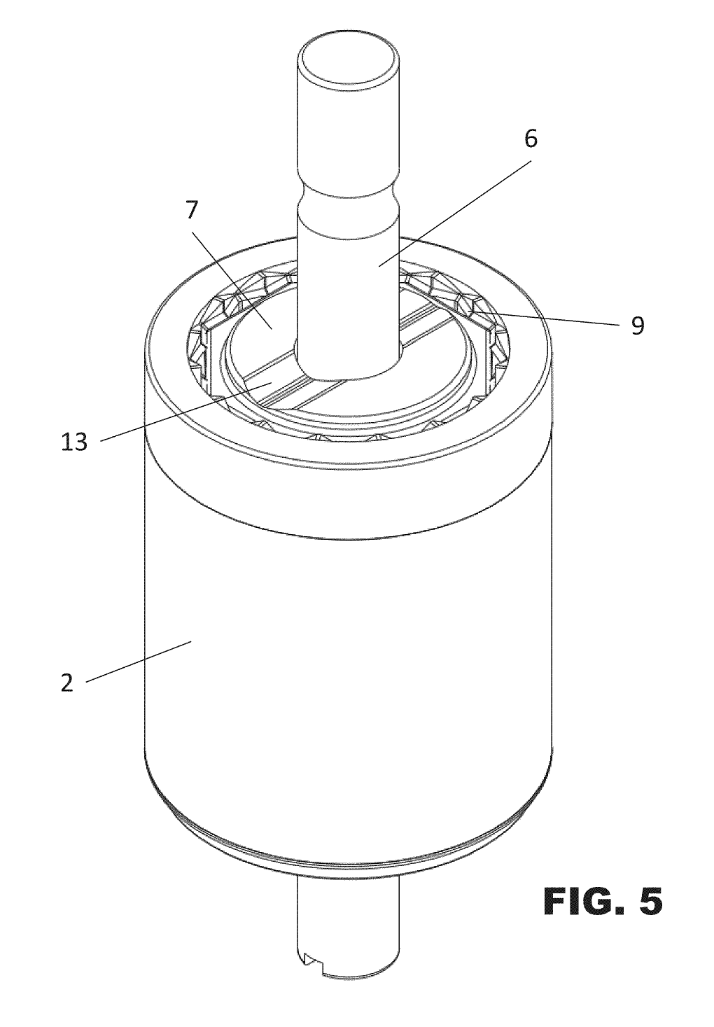

In accordance with a first preferred embodiment of this invention, shown in FIGS. 2, 4 and 5, the thrust bearing member is formed of a stepped insert 7 shaped to combine a step having a polygonal circumference and a step (facing the end of the bushing bearing 20) having a generally rounded circumference. The polygonal step fits securely within a track depression 8, in the rotor 2, surrounded by an internal surface having a complementary polygonal shape to that of the polygonal step, such as to block rotation of the thrust bearing insert 7 relative to the rotor 2. Further, this insert 7 comprises a central hole 14, placed centrally, for fitting around the motor shaft 6.

Preferably, the insert 7 has an outer circumferential edge 107 having a polygonal profile; in the example shown it is octagonal.

In order to further prevent the insert 7 from rotating relative to the rotor shaft 6, the internal circumferential surface of the rotor sleeve 2 is provided with a multifaceted surface 9.

Specifically, there is an octagonal insert 107 the lateral sides of which fit on the multifaceted internal circumferential surface 9 of the rotor sleeve 2.

The internal circumferential surface 9 has a generally circular configuration with its axis corresponding to the axis of the motor shaft 6. Furthermore, this internal circumferential surface 9 extends axially by a sufficient height such as not to have the insert 7 coming out of the annular space 8, once it has been fitted in place.

In this way, once fitted inside the rotor sleeve 8, the insert 7 becomes an integral part of the rotor 2, since it is held by the multifaceted sides of the internal circumferential surface 9.

This configuration allows having a rotor with an axial extension not increased by the presence of the insert 7 that performs the axial thrust bearing function.

Clearly, the internal space 8 is directly obtained on the end of the rotor 2 that receives the insert 7; in particular, on the end facing towards the impeller 5.

In order to ensure a high durability, the insert 7 can be made of a ceramic material based on alumina. Alternatively, graphite or a techno-polymer can be used. Examples of commercially available techno-polymers include PEEK polymers, a Polyether ether ketone, a colorless, organic, thermoplastic, polymer, in the polyaryletherketone family of polymers; and PPS polymers, i.e., Polyphenylene sulfide polymers, are engineering plastics, often used as substitutes for metals in engineering uses. These are high-performance thermoplastic polymers which can molded, extruded, or machined to high tolerances, so that they can be used as replacements for metal materials. Other techno-polymers include so-called PPA's, High Performance Polyamides, preferably formed having a backbone of Polyphthalamides, such as copolymers of terephthalic and isophthalic acids. Commercially, useful Polyphthalamides include Grivory polymers offered by EMS-CHEMIE.

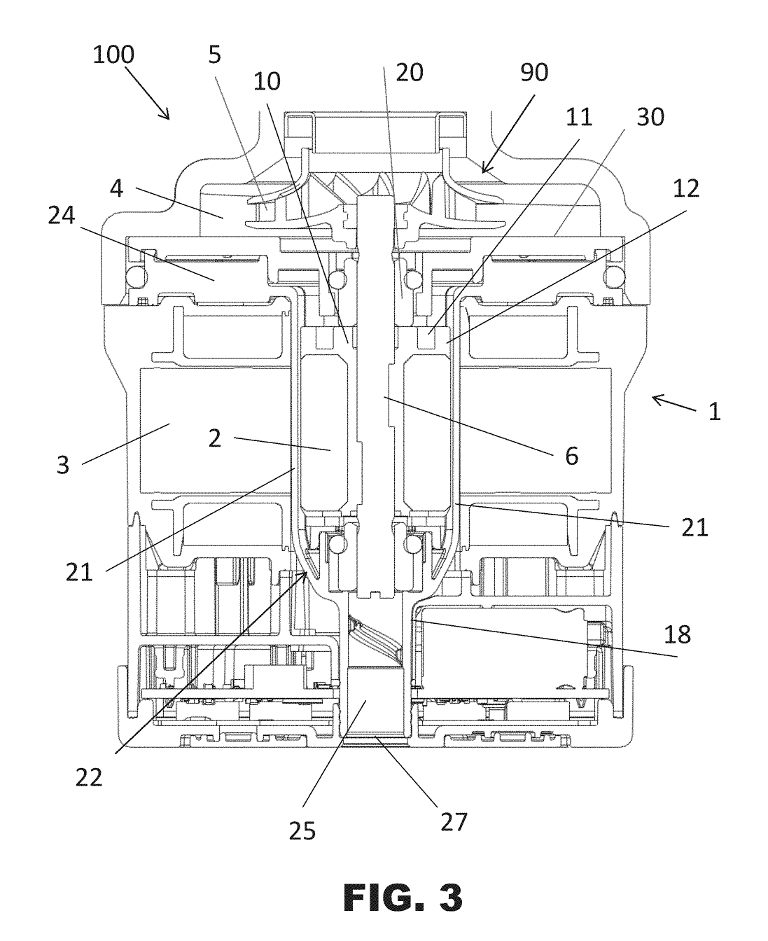

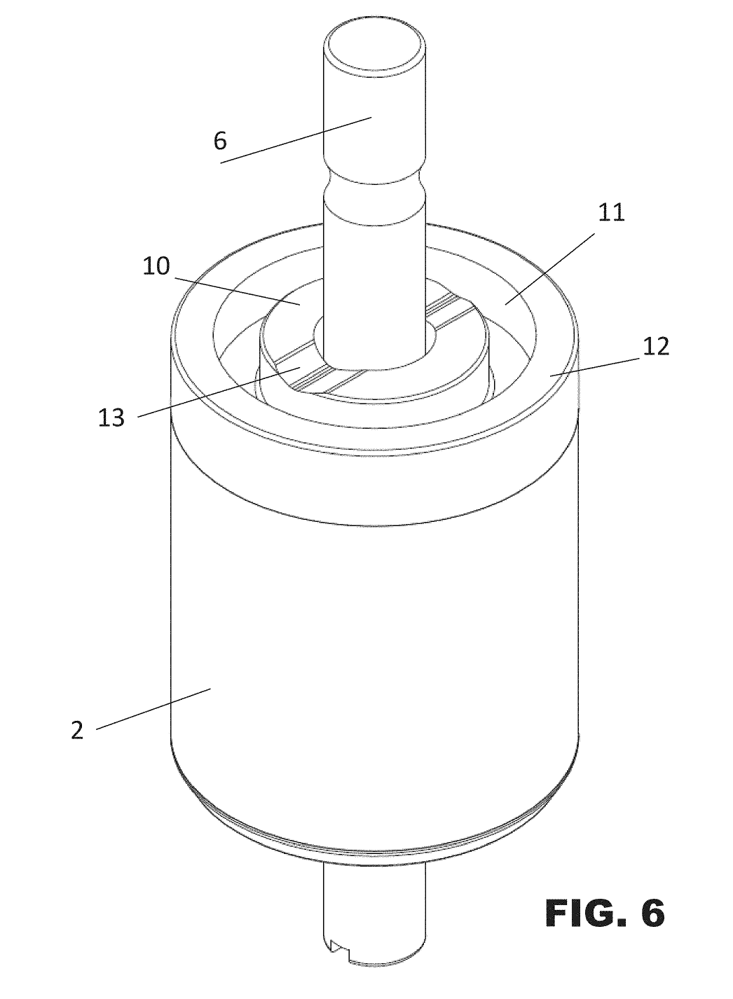

In accordance with a second embodiment, shown in FIGS. 3 and 6, the thrust bearing member 10 is formed as a unit, integrated with the material of the tubular sleeve 22 (surrounding the magnet of the rotor 2); the sleeve, or tubular body, can also be fabricated from such techno-polymers.

In practice, instead of having a separated insert that fits inside a track (as in the first embodiment), there is an integrated insert that is directly made during the forming of the rotor sleeve 2.

In the example shown, this integrated insert 10 is placed centrally to surround the shaft 6 on an end of the rotor. Outside the integrated insert 10 an annular groove 11 is present, which is in turn surrounded by an annular part 12 forming the most outer portion of the rotor 2 itself.

Preferably this integrated insert 10 is made of polymeric plastic material of the same type as the one used for the cover of the rotor magnet.

In order to improve lubrication, the thrust bearing member, in the two embodiments described above, has an embossed portion 13 facing towards the impeller 5. In the example of the drawings, this is shown as a diametrical groove 13, interrupted in the central area of passage of the shaft 6, formed on the face of the thrust bearing member that comes into contact with the end of the bushing bearing 20. The thrust bearing is located between the rotor 2 and the impeller 5, and rotates with the rotor.

Obviously, the skilled person, in order to meet contingent and specific needs, can make numerous changes and variants to the electric motor for a fluid circulator above disclosed, all within the scope of protection of the invention as outlined in the following claims.

The following invention is claimed:

1. An electric motor for a circulator pump comprising
a permanent magnet rotor (2),
a stator (3),
a supporting and containing hollow body (4) for the rotor (2) located centrally of the stator;
an impeller (5);
a shaft (6) firmly coupled at one end to the rotor (2) and at a second end to the impeller (5), such that rotation of the rotor (2) activates the impeller (5) to rotate;
said rotor (2) comprising an axial thrust bearing member (7; 10) made of anti-friction material and adapted for supporting axial loads that would otherwise cause the rotor and the shaft to move towards the impeller end of the circulator, the axial loads are produced during the fluid circulation in the circulator during rotation of the impeller;
said thrust bearing member being integrated inside the rotor itself, so that the thrust bearing member does not separate from the rotor during a motor disassembly and is so integrated that it cannot move axially relative to the shaft and the rotor; the thrust bearing member rotates together with the rotor and the shaft, without slip; the electric motor further comprising:
a bushing bearing (20) interposed between the rotor (2) and the impeller (5), said thrust bearing member being placed directly in contact with the end of the bushing bearing (20) nearest to the rotor (2).

2. The electric motor according to claim 1, wherein said thrust bearing member is further so integrated with the rotor and shaft that it rotates together with the rotor and the shaft, without slip.

3. The electric motor according to claim 1, wherein said thrust bearing member further comprises an insert (7) shaped in order to securely fit in a track (8) having an annular shape and being formed so that the central opening of said annular insert precisely fits around the motor shaft (6) such as to block the rotation of the thrust bearing member (7) relative to the rotor (2).

4. The electric motor according to claim 1, wherein said insert (7) comprises a circumferential edge having a polygonal profile.

5. The electric motor according to claim 1, wherein the circumferential edge has an octagonal profile.

6. The electric motor according to claim 4, wherein said track (8) comprises a circumferential side surface (9) embracing the insert polygonal edge (7), said side surface (9) being multifaceted.

7. The electric motor according to claim 3, wherein said insert (7) is made of a ceramic material based on alumina.

8. The electric motor according to claim 3, wherein said insert (7) is made of graphite or a techno-polymer.

9. The electric motor according to claim 1, wherein said thrust bearing member is formed by an insert (10) integrally formed with the material covering the rotor magnet (2).

10. The electric motor according to claim 9, wherein said insert (10) is made of plastic material.

11. The electric motor according to claim 1, wherein the bushing bearing (20) is clamped around and supports the motor shaft (6), the bushing bearing being located between the rotor (2) and the impeller (5), wherein the impeller end of the thrust bearing member being placed directly in contact with the end of the bushing bearing nearest the rotor.

12. The electric motor according to claim 11, wherein said thrust bearing member presents a hollow portion (13) facing the bushing bearing (20).

13. A circulator pump comprising the electric motor according to claim 1.
